(19) United States
(12) Patent Application Publication
(10) Pub. No.: US 2016/0078500 A1
(43) Pub. Date: Mar. 17, 2016

(54) HEALING-ADVERTISEMENT SYSTEM BASED ON NETWORK

(71) Applicant: YANGYOO Co., Ltd., Seoul (KR)

(72) Inventor: Kyoung Jun KIM, Seoul (KR)

(21) Appl. No.: 14/484,906

(22) Filed: Sep. 12, 2014

(51) Int. Cl. G06Q 30/02

(52) U.S. Cl. CPC G06Q 30/0279; G06Q 30/0258; G06Q 30/0273; G06Q 30/0256; G06Q 30/0267

(57) ABSTRACT

Provided is a healing advertisement system based on a network, in which an advertising expense provided by an advertiser is donated, a consumer, who consumes time while viewing an advertisement, actively donates, and a non-profit or done organization easily registers a donation program. The healing advertisement system allows consumers to proactively select the donation program and proceed with the donation and to access the donee. The satisfaction of the donation is increased since the donation is proactively performed. According to the healing advertisement system, a donee group easily implements a donation program by easily making the donation program in public.

### STATEMENT REGARDING PRIOR DISCLOSURE BY THE INVENTOR

The present application is based on Korean Patent Application No. 10-2012-0145432 filed on Dec. 13, 2012, which was published as KR 10-2014-0078002 on Jun. 25, 2014, which does not qualify as prior art under AIA 35 U.S.C. 102(b)(1)(A).

### BACKGROUND OF THE INVENTION

1. Field of the Invention

The present invention relates to an online advertisement system based on a network, more particularly, to a healing advertisement system based on a network, in which an advertising expense provided by an advertiser can be donated, a consumer, who consumes time while viewing an advertisement, can actively donate, and a donation organization such as a non-profit organization and donee organizations or groups can easily register a donation program in public.

2. Description of the Related Art

In the modern socialization process, in which society becomes more complex and sociality is emphasized, a donation culture is one of the most important social movements. Various researches are being conducted to spread this donation culture to encourage people to donate.

To encourage the donation culture, efforts to increase the satisfaction of a donator should be made, the donator should not feel discomfort but be intimate with the donee organization, and an aggressive publicity campaign is required so that the donee organization can easily come in contact with the donation activity.

Especially, a corporate social responsibility (CSR) of companies is being strongly emphasized in the modern society where corporate culture is developing.

Conventionally, various online donation systems, in which customers can easily access the system, are being proposed. A donation providing method using an online shopping mall system of donating reward points corresponding to a product when purchasing the product online, and donating a predetermined amount from product sales are typical examples of the online donation system.

Korean Unexamined Patent Application No. 2000-6177, “Method of electronic commerce on computer network and recording medium recorded with method,” proposes a donation system combined with an online shopping mall system for donating a certain amount of payment to a pre-registered donee organization.

But the described method only simply donates to a donee designated by a shopping mall or simply accumulates donations, so it is difficult for the donator to feel satisfaction for the donation, and it is also difficult for the shopping mall system or a seller providing the donation to feel satisfaction for providing the donation.

Also, it is difficult to recognize the described system as an ultimate solution for encouraging donations in that one needs to purchase a predetermined amount of goods to participate in the donation.

### SUMMARY OF THE INVENTION

An object of the present invention is not to simply donate to a certain donee, but to provide a healing advertisement system based on a network, in which consumers not only can proactively select the donee and proceed with the donation but also can easily access the donee and easily participate in the donation just by viewing an advertisement. In addition, the satisfaction of the donation action can be sufficiently felt since the donation is proactively performed, and the corporation providing the donation can also carry out the corporate social responsibility of providing the entire amount of the advertisement expense.

The healing advertisement system is a created name and refers to the present invention having features as described herein.

Furthermore, another object is to provide a healing advertisement system based on a network for a donee group to easily implement a donation program by easily opening the donation program to the public.

The healing advertisement system based on a network of the present invention provides a healing advertisement service, in which the advertiser produces an advertisement for a target customer to be advertised to and pays a predetermined advertisement expense to register the produced advertisement on the healing advertisement system, the donee organization registers a donation program to be executed on the healing advertisement system, and the user donates reward points accumulated from viewing the registered advertisement by selecting the registered donation program.

The healing advertisement system based on a network includes: a server to execute, i.e., process member registration of a donee group, a user and an advertiser, and to execute access control management of each user terminal to provide a healing advertisement service online; a healing advertisement server to provide a healing advertisement registration service for requesting an advertisement production and registering a produced advertisement as a healing advertisement, a donation program registration service for a registered domination group, and a donation service for providing reward points according to viewing of the advertisement and donation of the reward points; and a database to store and manage member information of the advertiser, the user and the donee group, which are registered to use the service, healing advertisement information, and donation program information registered by the donee group, wherein the healing advertisement server includes an advertisement registration unit allowing the advertiser registered as a member to request the advertisement production and to register the produced advertisement as the healing advertisement, a donation program management unit allowing the donee group registered as a member to register the donation program for a donee, a healing advertisement providing unit allowing the user to selectively view the registered healing advertisement and to provide the reward points to be used as donation to the user according to a result of the viewing, a donation management unit providing a registered donation program according to a request from the user, allowing the user to donate the reward points to a corresponding donation program according to a selection by the user, and managing accumulation of the donation donated by each donation program and execution of the donation program, a donation balancing unit to provide balancing information to a manager by receiving and balancing execution information of a completed donation program from the donation management unit, and to deposit the donation to an account registered to the corresponding donee group upon an authorization from the manager, and a healing advertisement control unit to provide and manage the healing advertisement service by managing the advertisement registration and the donation program registration by controlling the advertisement registration unit and the donation program management unit according to the request of the advertiser and the donee group, controlling the advertisement service through the healing advertisement providing unit according to the request of the user, and controlling and managing advertisement viewing information and donation execution information generated by the healing advertisement providing unit and the donation management unit.

According to the described healing advertisement system of the present invention, an advertiser can fulfill the CSR of indirectly participating in the donation culture and activity since the advertisement expense required to execute the advertisement is used for the donation, and the donee organization can also come in contact with the user without discomfort since the donee organization selectively registers the donation program to be executed as required.

Also, a proactive donation by a user is possible since the user can easily obtain reward points used for the donation by viewing the advertisement, and also the user can select the donation program to donate.

### BRIEF DESCRIPTION OF THE DRAWINGS

FIG. 1 and FIG. 2 are flow charts showing flows of a healing advertisement system based on a network of the present invention.

FIG. 3 is a block diagram showing an entire configuration of the healing advertisement system based on a network of the present invention.

FIG. 4 is a block diagram showing a detailed configuration of the healing advertisement server according to the present invention.

FIGS. 5-9 show exemplary embodiments of a screen of a smartphone, which is a portable mobile communication device, executing the healing advertisement service through an application operated in the smartphone according to the present invention, in which FIG. 5 shows a main screen page, FIG. 6 shows an inquiry screen page of the donation program, FIG. 7 shows an advertisement viewing screen page, FIG. 8 shows reward points and event page after viewing the advertisement and FIG. 9 shows a donation result screen page showing the result of the donation.

### DETAILED DESCRIPTION OF THE INVENTION

Hereinafter, a configuration and operation of a healing advertisement system based on a network of the present invention will be described with reference to an embodiment shown in the accompanying drawings.

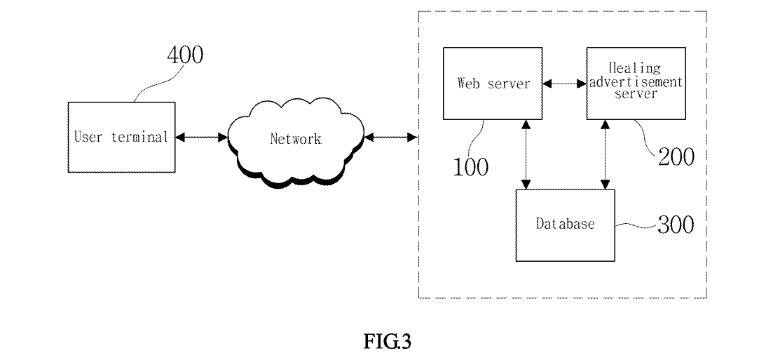

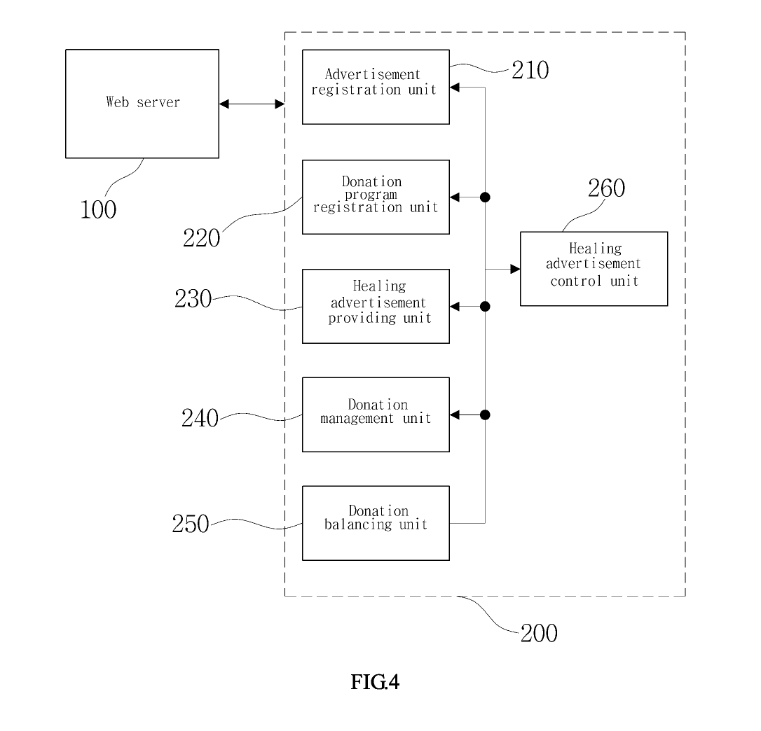

As shown in FIG. 3 and FIG. 4, the healing advertisement system based on a network includes: a web server 100 to execute a member registration of a donee group, a user and an advertiser, and to execute an access control management of each user terminal 400 to provide a healing advertisement service online; a healing advertisement server 200 to provide a healing advertisement registration service for requesting an advertisement production and registering a produced advertisement as a healing advertisement, a donation program registration service for a registered donee group, and a donation service for providing reward points according to viewing of the advertisement and donation of the reward points; and a database 300 to store and manage member information of the advertiser, the user and the donee group, which are registered to use the service, healing advertisement information, and donation program information registered by the donee group, wherein the healing advertisement server comprises: an advertisement registration unit 210 allowing the advertiser registered as a member to request the advertisement production and to register the produced advertisement as the healing advertisement, a donation program management unit 220 allowing the donee group registered as a member to register the donation program for a donee, a healing advertisement providing unit 230 allowing the user to selectively view the registered healing advertisement and to provide the reward points to be used as donation to the user according to a result of the viewing, a donation management unit 240 providing a registered donation program according to a request from the user, allowing the user to donate the reward points to a corresponding donation program according to a selection by the user, and managing accumulation of the donation donated by each donation program and execution of the donation program, a donation balancing unit 250 to provide balancing information to a manager by receiving and balancing execution information of a completed donation program from the donation management unit 240, and to deposit the donation to an account registered to the corresponding donee group upon an authorization from the manager, and a healing advertisement control unit 260 to provide and manage the healing advertisement service by managing the advertisement registration and the donation program registration by controlling the advertisement registration unit 210 and the donation program management unit 220 according to the request of the advertiser and the donee group, controlling the advertisement service through the healing advertisement providing unit 230 according to the request of the user, and controlling and managing advertisement viewing information and donation execution information generated by the healing advertisement providing unit 230 and the donation management unit 240.

The healing advertisement system based on a network of the present invention described above provides a system allowing:
(a) a CSR marketing service of the advertiser (corporate), in which the advertiser indirectly participates in the donation activity by allowing the advertiser to use the advertisement expense used to register the advertisement for the donation,
(b) a donation program registration service, in which the donee organization selectively registers the donation program the donee organization is promoting
(c) a donation service to provide the registered advertisement to the user, to provide the reward points that is able to be used as the donation to the user who viewed the advertisement, and to provide a donation service for the user to donate the reward points by selecting among the registered donation programs.

The web server 100 executes control and management of a web page to provide a member registration of the advertiser, the donation organization, and the user (viewer), and access control to a user terminal 300 and to provide the healing advertisement service.

According to an embodiment of the present invention, the user terminal 400 is defined as a unit or means for the advertiser using the healing advertisement service, the donee group for registering donation programs, and the user for viewing the advertisement, and the embodiment is described in terms of the advertiser, the donee group, or the user (customer) viewing the advertisement for easy understanding.

The advertiser is also a user registered as an advertiser member by registering the advertisement, the donee group is also a user of the service registered as a donee group member, and the customer is also a user registered as a customer member viewing the registered advertisement.

Only authorized members who have passed a separate authorization process during the member registration are registered so that the users using the service may have confidence in the donee group.

The healing advertisement server 200 is a server to provide the healing advertisement service, and includes the advertisement registration unit 210, the donation program registration unit 220, the healing advertisement providing unit 230, the donation management unit 240, the donation balancing unit 250, and the healing advertisement control unit 260.

The advertisement registration unit 210 registers the advertisement produced by the registered member as a healing advertisement. In addition, not only a pre-produced advertisement may be registered, but the advertiser may request a production of an advertisement to the healing advertisement system.

A process of registering the advertisement in the advertisement registration unit 210 comprises: attaching a produced advertisement file and providing advertisement category information, description information, and advertisement duration information; calculating and providing a bill for an advertisement expense based on the information (advertisement file, advertisement duration) registered by the advertiser; and enabling the advertiser to pay for the advertisement expense.

When the system receives the request to produce the advertisement, the system produces the advertisement and provides the advertisement to the advertiser to register the advertisement, or the manager of the healing advertisement system may register the advertisement.

The advertisement registration unit 210 may include an advertisement expense payment unit to pay for the advertisement expense for the registration of the advertisement.

The donation program registration unit 220 provides a donation program registration process in such a way a donee group member registers the donation program with regard to the donee.

The donation program includes the done name, a donation target amount, and duration information, and the donation program is only registered by the registered donee group member.

The healing advertisement providing unit 230 allows the user to select a registered healing advertisement for viewing, and provides the reward points usable for the donation to the user according to the viewing result. The healing advertisement providing unit 230 includes: an advertisement searching unit allowing the user to categorically inquire and search for the registered advertisement; an advertisement playing unit to play the selected advertisement; and an accumulated point providing unit to provide reward points allocated in the advertisement after the advertisement has been played to the user.

The donation management unit 240 allows the user to donate the reward points accumulated by viewing the advertisement to the donation program the user wishes to donate to, and includes a donation program checking unit allowing the user to search for the registered donation program according to a user request and providing the execution information of the donation program; a donation unit to provide a donation process for allowing the user to select the corresponding donation program and donate the reward points to the donation program; and a donation program management unit to manage the accumulation of the donation donated to each donation program and to manage execution and completion of the donation program.

The donation balancing unit 250 provides balancing information to a manager by receiving and balancing execution information of a completed donation program from the donation management unit 240, and deposits the donation to the account registered to the corresponding donee group.

The healing advertisement control unit 260 provides a process of controlling the healing advertisement service, and the process of controlling the healing advertisement service includes: registering the advertisement by controlling the advertisement registration unit 210 according to the request of the donee group; registering the donation program by controlling the donation program registration unit 220; providing the advertisement through the healing advertisement providing unit 230 according to the request of the user and managing the reward points of the each user according to the provided advertisement; controlling the donation management unit 240 to enable the user to donate the reward points, which are accumulated to the user, by selecting the registered donation program; controlling and managing the execution and completion of the donation program according to the duration and the donation target amount assigned in the donation program by controlling the donation management unit 240; providing completion information of the donation program to the manager by receiving the completed donation program information by controlling the donation balancing unit 250 and providing the donation according to the account information of the registered donee group upon an authorization from the manager.

The healing advertisement providing unit 230 includes an advertisement viewing information providing unit to store the advertisement viewing information in the database by extracting the advertisement viewing information after playing the advertisement according to the healing advertisement control unit 260, and to provide the corresponding advertisement to the advertiser.

The advertisement viewing information includes donation accumulation information and the donation information, and the donation accumulation information includes an accumulated amount and accumulation target user information, and the accumulation target user information includes age and gender information.

And the donation information comprises the donation program information to which the reward points were donated by the accumulation target user of the corresponding advertisement.

And the donation management unit 240 includes a unit which provides donation ranking information to the public and provides each user with the donation ranking information and donation history information corresponding to each user.

A donation certificate may be provided when providing the donation history information to the corresponding user and an individual certificate may be provided for each donee group. The donation certificate may be printed online by the user, or provided to the user by mail after being printed.

The advertisement viewing information and the donation ranking information, and the donation history information may be provided and inquired through a screen accessed by the advertiser and the corresponding user, and also may be provided through contact information of the registered user member and, since this may be provided by a conventional method, a detailed description is skipped.

The database 300, in which information required by the healing advertisement service and information generated by the healing advertisement service is stored and managed, stores and manages the member information, the registered advertisement information, the donation program information and the advertisement viewing information, donation ranking information, and donation history information.

The member information is for the advertiser, the user, and the donee group.

The member information generally includes personal information comprising a name and an address, system access information comprising an identity (ID) and a password, and service history information of the advertiser, the user, and the donee group. The advertisement information is registered by the advertiser. The donation program information is registered by the donee group. And, the web server 100 and the healing advertisement server 200 may be configured as one server not a separate server according to an embodiment of the present invention.

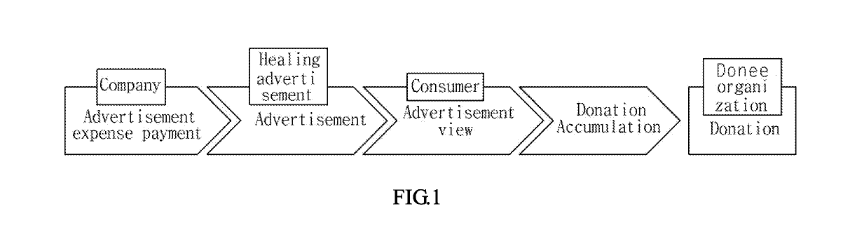

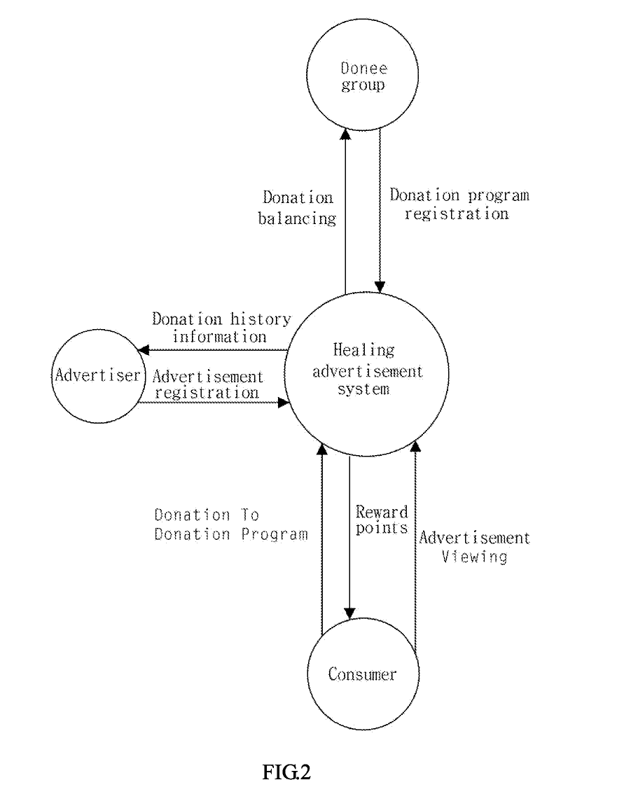

Hereinafter, the operation of the healing advertisement system based on a network of the present invention having the described configuration is described. FIG. 1 and FIG. 2 are flow charts showing flows of the healing advertisement service of the present invention.

The healing advertisement service of the present invention allows the advertiser to produce the advertisement to be advertised to the public through the present advertisement system and to register the produced advertisement with the advertisement system by paying the predetermined advertisement expense, the donee group to register the donation program the donee group wishes to promote and execute through the healing advertisement system, and the user to donate reward points to a donee group accumulated by viewing the registered advertisement and selecting the registered donation program.

Therefore, the advertisement expense the advertiser pays is provided to the user as reward points and the provided reward points can be donated to the donation program of the donee group.

Hereinafter, the healing advertisement service is further described in detail. The advertisement registration unit 210 provides an advertisement registration process in such a way that when the advertiser selects to register the advertisement, the web server 100 requests the selection to the healing advertisement server 200, and the healing advertisement server 200 allows the advertiser to register the advertisement.

Here, the process may be configured for the web server 100 to limit the advertisement registration so that only the registered advertiser may register the advertisement.

The advertisement registration unit 210 executes the registration of the advertisement to be registered (attachment of electronic data for the advertisement), registration of the advertisement information (advertisement duration, advertisement description, advertisement category) and payment of the advertisement expense.

The advertisement registration unit 210 provides the advertisement expense information according to a size of an advertisement file and the advertisement duration and allows the advertiser to pay the advertisement expense accordingly. The advertisement registration and the payment process may be generally executed in a conventional manner.

Here, the advertisement registration unit 210 may further include an event registration unit. The event registration unit allows the advertiser to register an event when viewing the advertisement, and when the event registered by the advertiser is completed, the event may be set to accumulate reward points to the user completing the event, and the event may be configured to convert these reward points for product purchase afterwards or for donation. Meanwhile, in some cases, events may of course be configured to provide various prizes of products of the advertising company, movies, or concert tickets to generate user interest.

When the payment for the advertisement of the advertiser is completed through the advertisement registration unit 210, the healing advertisement control unit 260 registers the advertisement the advertiser requests to be registered with the database 300, and registers to a viewable advertisement list so that the user may view the advertisement. The healing advertisement providing unit 230 provides the advertisement to the user according to the viewable advertisement list information.

Meanwhile, the donation program is registered by the donee group member registered in the web server 100. This is to provide reliability to the user and the advertiser, and the donee group is registered as a member after the healing advertisement system inspects and verifies the donee group according to a predetermined method.

When the web server 100 receives a request for registering the donation program from the user terminal 400, the user requesting the donation program registration is determined whether the user is a registered donee group member. The web server 100 requests the user to log in when the user is not logged in, and then determines whether the user is a registered donee group member.

Here, member registration is requested to the user if not registered as a member by enabling the member registration, and thus the member registration is executed by classifying the user into the donee group member, the advertiser member, or the normal user member when registering membership.

For the donee group member, the web server 100 requests registration of the donation program to the healing advertisement server 200, and the healing advertisement server 200 provides the donation program registration process.

The donation program registration unit 220 of the healing advertisement server 200 requests the member to register a detailed description information of the donation program including the donee, the duration of the donation program, target amount information and an intent and guide information of the corresponding donation program, and the donee group member registers the information according to a described donation program registration method.

When the donation program registration is completed through the donation program registration unit 220, the healing advertisement control unit 260 registers the donation program to the database 300 and opens the donation program to the normal user, the advertiser, and the donee group member through the donation management unit 240.

Meanwhile, the healing advertisement control unit 260 opens and manages the advertisement and the donation program described above through the healing advertisement providing unit 230 and the donation management unit 240.

The user may view the advertisement publicly available in the healing advertisement system while being logged in. The user may view the advertisement the user is interested in according to the process provided from an advertisement searching unit of the healing advertisement providing unit 230.

The advertisement searching unit may provide a search unit allowing the user to search for each of advertisement category, event registration status, reward points ranking, and viewing donation ranking information. The healing advertisement providing unit 230 accumulates the registered reward points to the corresponding user when the user views the advertisement.

When the user views the advertisement as described above, the healing advertisement providing unit 230 generates the advertisement viewing information based on the corresponding user member information and updates the advertisement viewing information registered in the database 300.

And then, since the user may donate the accumulated reward points to the registered donation program, the user may select the donation program the user wishes to donate to through a donation program inquiry unit of the donation management unit 240. The donation program inquiry unit enables the user to inquire of the donation program using each donee group and each keyword.

When the user selects to donate to the corresponding donation program, the donation unit of the donation management unit 240 allocates the amount of reward points the user selected among the reward points of the user as a donation.

The donation management unit 240 manages the donation program and checks if the duration has expired or the target amount is reached by checking the donation duration and the target amount in the registered donation program information.

When the donation management unit 240 verifies if the duration of the donation program has completed or the target amount is reached, the healing advertisement control unit 260 controls the donation balancing unit 250 to check the donated amount and requests the manager to verify a balance authorization request.

When the manger requests the balancing authorization, the donation balancing unit 250 deposits the corresponding amount to a registered account of the donee group, which registered the donation program.

In the embodiment of the present invention described above, the web server is configured and technological configuration for implementing on the web is shown, but a configuration that may be implemented on an application operating on a mobile operating system such as Android, I, etc. may also be similarly configured.

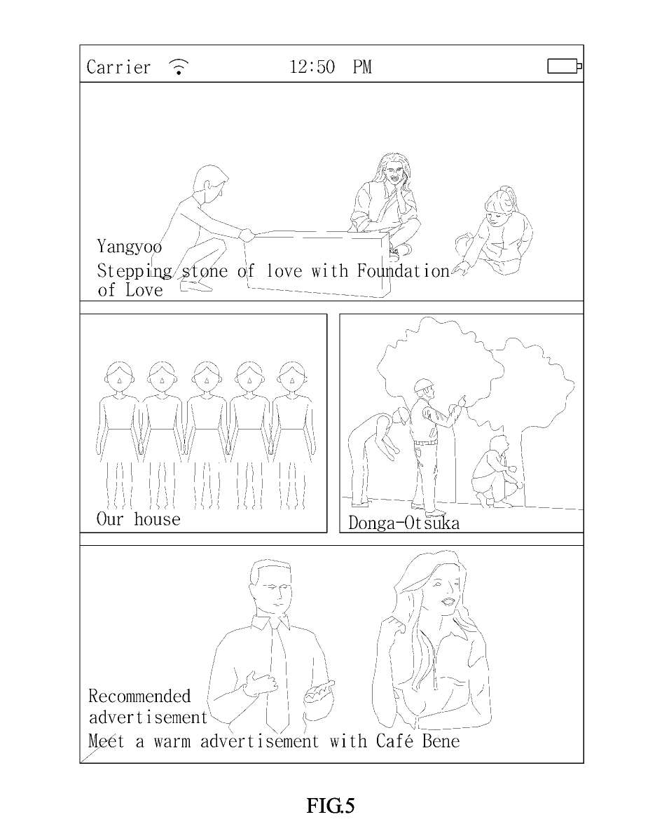

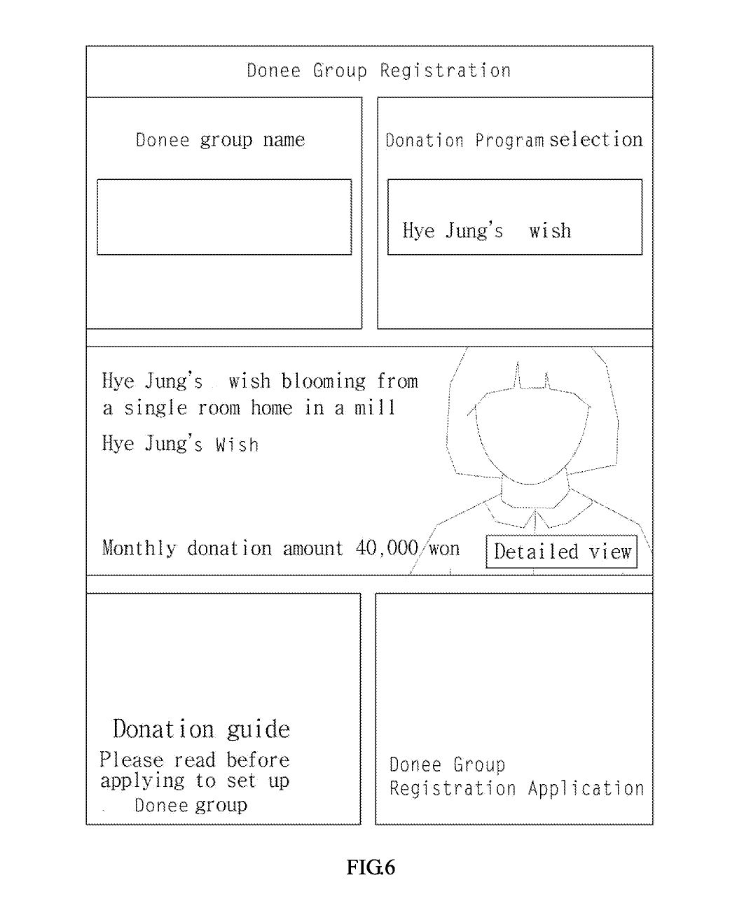

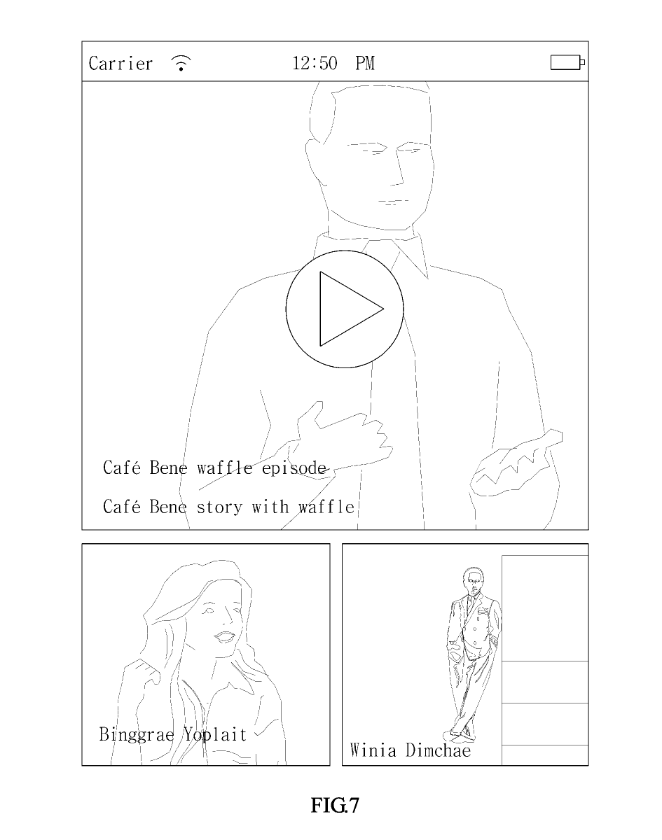

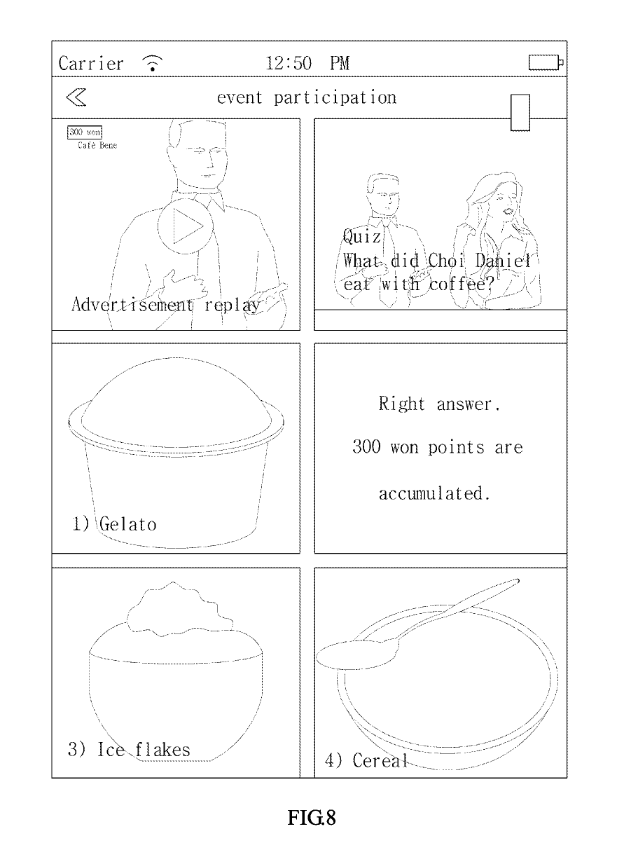

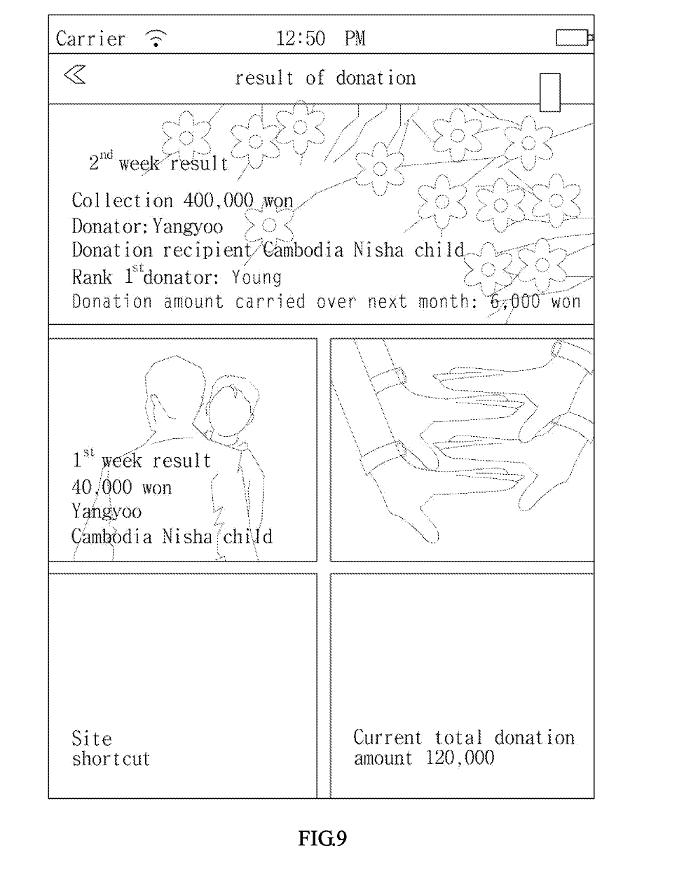

FIG. 5 to FIG. 9 show exemplary embodiments of a screen of a smartphone, which is a portable mobile communication device operating on a predetermined operating system, executing the healing advertisement service through an application operating in the smartphone according to the present invention. FIG. 5 shows a main screen page, FIG. 6 shows an inquiry screen page of the donation program, FIG. 7 shows an advertisement viewing screen page, FIG. 8 shows reward points and event page after viewing the advertisement, and FIG. 9 shows a donation result screen page showing the result of the donation.

The healing advertisement system of the present invention described above provides a space for the donation program to be executed and a space where the normal user may participate in the donation, and business activity of receiving a predetermined commission by providing the advertisement, which is a profit-making activity of a conventional company, is possible, and as an exemplary embodiment, the system may provide the advertiser an opportunity to re-donate by returning the commission to the advertiser.

Accordingly, by allocating only a fixed percentage (for example, 70%) of the advertisement expense to the user as the reward points with respect to the advertisement and allocating a fixed percentage (for example, 30%) of the advertisement expense to the corresponding advertiser as donation reward points while providing a corporate group room for the corresponding advertiser, the reward points may be accumulated to the corporate group room with respect to the advertisement (same advertisement as the normal user) viewed by managers and employees of the corresponding advertiser registered to the corporate group room, and when the donation reward points (for example, 30% of advertisement expense) allocated to the corporate group room is reached, the reward points may be exchanged with money and provided to the corresponding advertiser. That is, a fixed amount of the advertisement expense may be provided to be used for a CSR business of the advertiser by returning the amount to the corresponding advertiser.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A healing advertisement system based on a network, the healing advertisement system comprising:
a control server configured to process a member registration of a donee group, a user and an advertiser, and to process an access control management of a user terminal to provide a healing advertisement service online;
a healing advertisement server configured to provide a healing advertisement registration service for requesting an advertisement production or registering a produced advertisement as a healing advertisement, a donation program registration service for the registered donee group, and a donation service for providing reward points to the user based on a viewing of the healing advertisement and a donation of the reward points to the donee group; and
a database configured to store and manage member information of the advertiser, the user and the donee group, all of which are registered to use the service, healing advertisement information, and donation program information registered by the donee group,
wherein the healing advertisement server comprises:
an advertisement registration unit configured for allowing the registered advertiser to request the advertisement production and to register the produced advertisement as the healing advertisement;
a donation program management unit configured for allowing the registered donee group to register a donation program for a donee;
a healing advertisement providing unit configured for allowing the user to selectively view the registered healing advertisement and to provide the reward points to be used as the donation to the donee by the user according to a result of the viewing;
a donation management unit configured for providing the registered donation program according to a request from the user, allowing the user to donate the reward points to the donation program according to a selection by the user, and managing accumulation of the donation contributed to the donation program and execution of the donation program;
a donation balancing unit to provide balancing information to a manager by receiving and balancing execution information of a completed donation program from the donation management unit, and to deposit the donation to an account registered to the donee group upon an authorization from the manager; and
a healing advertisement control unit to provide and manage the healing advertisement service by managing the advertisement registration and the donation program registration by controlling the advertisement registration unit and the donation program management unit according to the request of the advertiser and the donee group, controlling the advertisement service through the healing advertisement providing unit according to the request of the user, and controlling and managing advertisement viewing information and donation execution information generated by the healing advertisement providing unit and the donation management unit.

2. The healing advertisement system of claim 1, wherein registering the produced advertisement in the advertisement registration unit comprises:
attaching a produced advertisement file and registering advertisement category information, description information, and advertisement duration information;
calculating and providing an advertisement expense based on the advertisement file and advertisement duration registered by the advertiser; and
enabling the advertiser to pay for the advertisement expense.

3. The healing advertisement system of claim 1, wherein the donation program registration unit provides a donation program registration process in such a way that a donee group member authorized to register the donation program through a separate authorization process upon the membership registration registers the donation program, and the donation program registration process comprises registering the donation program including the donee, a donation target amount, and duration information.

4. The healing advertisement system of claim 1, wherein the healing advertisement providing unit comprises:
an advertisement searching unit for allowing the user to categorically inquire and search for the registered advertisement;
an advertisement playing unit configured to play the selected advertisement; and
an accumulated point providing unit configured to provide the reward points allocated in the advertisement after the advertisement has been played to the user, and
wherein the donation management unit comprises:
a donation program checking unit for allowing the user to search for the registered donation program according to a user request and providing the execution information of the donation program;
a donation unit configured to provide a donation process for allowing the user to select the donation program and donate the reward points to the donation program; and
a donation program management unit configured to manage the accumulation of the donation donated to each donation program and to manage execution and completion of the donation program.

5. The healing advertisement system of claim 1, wherein the healing advertisement control unit provides a process of controlling the healing advertisement service, and the process of controlling the healing advertisement service comprises:
registering the advertisement by controlling the advertisement registration unit according to the request of the donee group;
registering the donation program by controlling the donation program registration unit;
providing the advertisement through the healing advertisement providing unit according to the request of the user and managing the reward points of each user according to the provided advertisement;
controlling the donation management unit to enable the user to donate the reward points, which are accumulated to the user, by selecting the registered donation program;
controlling and managing the execution and completion of the donation program according to a duration and a donation target amount assigned in the donation program by controlling the donation management unit;
providing completion information of the donation program to the manager by receiving the completed donation program information by controlling the donation balancing unit and providing the donation according to the account information of the registered donee group upon an authorization from the manager.

6. The healing advertisement system of claim 1, wherein the healing advertisement providing unit comprises an advertisement viewing information providing unit to store the advertisement viewing information in the database by extracting the advertisement viewing information after playing the advertisement according to the healing advertisement control unit, and to provide the corresponding advertisement to the advertiser,
wherein the advertisement viewing information comprises the donation accumulation information and the donation information,
wherein the donation accumulation information comprises an accumulated amount and accumulation target user information,
wherein the accumulation target user information comprises age and gender information, and
wherein the donation information comprises the donation program information donated by the accumulation target user of the corresponding advertisement.

7. The healing advertisement system of claim 1, wherein the donation management unit comprises a unit which opens donation ranking information in public and provides the user with the donation ranking information and donation history information corresponding to the user.

8. The healing advertisement system of claim 7, wherein a donation certificate is provided when providing the donation history information to the corresponding user and an individual certificate is provided for each donee group.

9. The healing advertisement system of claim 1, wherein the database stores and manages the member information, the registered advertisement information, the donation program information and the advertisement viewing information, donation ranking information, and donation history information,
wherein the member information is for the advertiser, the user, and the donee group, and the member information comprises personal information comprising a name and an address, system access information comprising an identity and a password, and service history information of the advertiser, the user, and the donee group,
wherein the advertisement viewing information comprises the donation accumulation information and donation information, the donation accumulation information comprising an accumulated amount and accumulation target user information including age information and gender information of the user, and
wherein the donation information comprises donation program information donated from an accumulation target user of the corresponding advertisement.

10. The healing advertisement system of claim 1, wherein the advertisement registration unit further comprises an event registration unit for allowing the advertiser to register an event to be executed when the user views the advertisement.

11. The healing advertisement system of claim 4, wherein the advertisement searching unit provides a search and inquiry unit for allowing the user to search for one of advertisement category, event registration status, reward points ranking, and viewing ranking information.

12. The healing advertisement system of claim 2, wherein the healing advertisement server comprises a process unit that performs:
allocating a predetermined percentage of the advertisement expense paid when the advertisement is registered to the user as the reward points for the advertisement;
providing a corporate group room for the corresponding advertiser while allocating the predetermined percentage of the advertisement expense to the corresponding advertiser as the donation reward points,
allocating the reward points to the corporate group room for the advertisement registered to the corporate group room and viewed by manager and employee members of the corresponding advertiser; and
providing accumulated the donation reward points to the corresponding advertiser by balancing an account of the accumulated donation points when the accumulated donation points allocated to the corporate group room is completed.

13. The healing advertisement system of claim 1, wherein the system is configured to provide the healing advertisement service to a user terminal such that the healing advertisement service is provided through an application operated by a mobile operating system in the mobile terminal.
